(19) United States
(12) Patent Application Publication
(10) Pub. No.: US 2011/0131780 A1
(43) Pub. Date: Jun. 9, 2011

(54) Device For Adjusting A Quarter Turn Fastener

(76) Inventor: William Wesley Weaver, Orange, VA (US)

(21) Appl. No.: 12/901,708

(22) Filed: Oct. 11, 2010

Related U.S. Application Data
(60) Provisional application No. 61/283,568, filed on Dec. 4, 2009.

(51) Int. Cl. B25B 27/00

(52) U.S. Cl. 29/270

(57) ABSTRACT

Device for adjusting quarter turn fasteners including a stabilizing member configured to engage each rivet in linear alignment therewith to press against rivets of a DZUS® quarter turn fastener. A second component includes a spring adjustment member for engagement with the spring to move the spring either toward or away from the support surface. An operator element is provided in operational association with the adjustment member to allow manual adjustment of the spring by movement of the adjustment member in coordination with operation of the stabilizing member.

### CROSS REFERENCE TO RELATED APPLICATIONS

This application claims the benefit of U.S. Provisional Patent Application Ser. No. 61/283568 filed Dec. 7, 2009.

### BACKGROUND OF THE INVENTION

The present invention relates broadly to special purpose hand tools and, more particularly, DZUS® is the subject of U.S. Trademark Registrations numbers 2833830 and 549508. The mark DZUS® is used for metal, quick acting, self locking fasteners and fastener parts and accessories including studs, fastener springs, fastener grommets, fastener retainers, and fastener receptacles. DZUS® fasteners were developed in the early 30s and are widely used in many applications including automotive and aviation endeavors. DZUS® fasteners are particularly useful in securing panels over openings in car bodies or aircraft fuselages. Typical DZUS® fasteners are disclosed in FIGS. 1 and 2 which will be explained in greater detail hereinafter.

Generally, the DZUS® fastener includes a wire extending between two rivets and formed into a spring by the coiled nature of the wire. The wire comes off each rivet at an approximately 30 degree angle and bisects an opening in its support plate. The support plate with the rivets and spring is secured to the removable panel, such as an automotive hood. An opening in the panel is formed in registry with the opening in the support plate of the fastener. A stud is configured for spring engagement with a curved slot forming a camming surface in the body of the stud. The stud includes a head which commonly has a slot for screwdriver use or maybe fitted with a D-ring for hand use. A quarter turn of the stud is required for fastening and unfastening the fastener. When the stud is fitted into the opening and engages the spring, a 90 degree turn locks the stud in place against the spring, thereby securing at least a portion of the panel to the body of the vehicle. Typically, multiple fasteners are used for each panel and, if the panel is square, typically a fastener will be placed at each corner. Accordingly, with one quarter turn, the stud can be removed and with all the studs removed, the panel may be removed from the vehicle.

One of the problems associated with a DZUS® fastener is that over time, the spring can become distorted, bent or otherwise moved away from a position wherein the stud can engage the spring for a locking turn. This typically occurs even with the spring fixed solidly to the rivets.

The distortion of the spring may be toward the support surface or away from the support surface. If the spring moves away from the support surface, then the stud cannot engage the spring. If the spring moves closer to the support surface, then the stud will not fully engage the spring to create spring tension and the fastener will not hold fast. In any event a distortion of the spring prevents proper alignment of the spring and the slot in the stud for engagement and therefore, the entire fastener has failed.

The springs used for the fasteners are typically malleable to the extent that they can be readjusted or repositioned or simply bent into the proper configuration for further use and further engagement by the studs portion of the fastener. An impediment to proper adjustment is the position that the backing plates and spring occupy with respect to the vehicle to which they are mounted. Accordingly, manual access to the spring may be limited and therefore, even removal of the fastener base may be required. In addition, a fulcrum may be required to bend the spring back in to a proper orientation and with fiberglass panels or other thin material, providing a fulcrum against the panel could result in damage to the panel.

Therefore, there exists a need for a tool, operable by hand, that will engage the spring of a DZUS® fastener for adjustment thereof, whether the adjustment directs the spring toward the support surface or away from the support surface.

### SUMMARY OF THE INVENTION

An object of the present invention is to provide a handheld device that can be used to adjust the spring of a DZUS® fastener without disturbing the remainder of the fastener while the fastener is mounted in its original and useful position.

It is also an object of the present invention to provide such a device that can be used on the spring side of the mounting surface to move the spring either toward or away from the mounting surface.

To those ends, the present invention provides multiple embodiments of a device for adjusting quarter turn fasteners. Common to all the embodiments is a stabilizing member which is configured to engage each rivet in substantially linear alignment therewith to press against the rivets. A second component includes a spring adjustment member for engagement with the spring to move the spring either toward or away from the support surface. An operator element is provided in operational association with the adjustment member to allow manual adjustment of the spring by movement of the adjustment member in coordination with operation of the stabilizing member.

More specifically, the present invention is directed to a device for adjusting a quarter turn fastener, the quarter turn fastener being of the type having a spring extending between at least two spring fastening elements fixed to a support panel The support panel is formed with an access opening adjacent the spring for access to the spring by a removable stud configured for spring engagement. The present device includes a generally elongate body including a first arm including a first gripping portion and a mating portion; a first adjustment head portion operatively associated with the first arm for operative engagement with the at least two spring fastening elements; a second arm including a second gripping portion, the second arm being pivotably mounted to the first arm at the mating portion, thereby defining a pivot axis along the body, with the pivot axis being intermediate the gripping portions and the first adjustment head portion; and a second adjustment head portion for spring engagement and spring movement, the second adjustment head portion being operatively associated with the second arm, wherein movement of the second arm causes movement of the second adjustment head portion. Therefore, relative movement of at least one of the first arm and the second arm toward the other causes the first adjustment head portion and the second adjustment head portion to be urged toward one another thereby directing pressure on the spring fastener elements by the first adjustment head portion while simultaneously directing pressure against the spring by the second adjustment head portion for selective spring adjustment.

Preferably, the first adjustment head portion includes a traversely extending support member attached to an end portion of the first arm, and a pair of spring fastener engagement elements projecting laterally away from the traversely extending support member in a manner substantially perpendicular to the support member for placing substantially equal pressure on each spring fastening element using the first arm. The traversely extending support member may be rotatably mounted to the first arm.

It is preferred that the second adjustment head portion includes a spring engagement member attached to an end portion of the second arm.

Preferably, the first arm is formed with a cavity for carrying the first adjustment head portion and the second adjustment head portion at least partially therein.

It is further preferred that the second adjustment head portion is formed on a slider disposed within the cavity for reciprocal motion therein, with the slider being formed with a first gear rack thereon, and with the second arm being formed with a second gear rack for operative engagement with the first gear rack for causing linear motion of the slider when the second arm is urged toward the first arm.

According to one preferred embodiment of the present invention, the device is formed in a manner similar to a set of pliers, with two handles pivotably mounted to one another. All embodiments of the present invention are configured for use when accessing the spring side of the mounted surface or panel.

To those ends, the present invention can also be described as a device for adjusting a quarter turn fastener, with the quarter turn fastener being of the type having a spring extending between at least two spring fastening elements fixed to a support panel. The support panel defines a spring side wherein the spring projects therefrom and an outer side wherein the spring does not project therefrom. The support panel is formed with an access opening adjacent the spring for access to the spring from the outer side by a removable stud configured for spring engagement. The present device includes a generally elongate body including a first arm including a first gripping portion and a mating portion; a first adjustment head portion operatively associated with the first arm for operative engagement with the at least two spring fastening elements from the spring side of the panel; a second arm including a second gripping portion, the second arm being pivotably mounted to the first arm at the mating portion, thereby defining a pivot axis along the body, with the pivot axis being intermediate the gripping portions and the first adjustment head portion; and a second adjustment head portion for spring engagement and spring adjustment movement, the second adjustment head portion being mounted to one end of the second arm, wherein movement of the second arm causes movement of the second adjustment head portion.

Therefore, urging the first arm and the second arm toward one another causes the first adjustment head portion and the second adjustment head portion to be urged toward one another thereby directing pressure on the spring fastener elements by the first adjustment head portion while simultaneously directing pressure against the spring by the second adjustment head portion for spring adjustment.

Preferably, the first adjustment head portion includes a traversely extending support member attached to an end portion of the first arm, and a pair of spring fastener engagement elements projecting laterally away from the traversely extending support member in a manner substantially perpendicular to the support member for placing substantially equal pressure on each spring fastening element using the first arm. The traversely extending support member may be rotatably mounted to the first arm.

It is preferred that the second adjustment head portion includes a spring engagement member attached to an end portion of the second arm. Preferably, the spring engagement member is formed as a generally planar member projecting outwardly from the second arm configured for rotational movement about the pivot axis in a direction opposite that of the arm rotation about the pivot axis.

Notably, according to the foregoing embodiment, the stabilizing member is rotatably fixed to one end of a first handle while the spring adjustment member is attached to the similar end of the remaining handle. The relationship is illustrated in FIG. 4. Since the handles are pivotally mounted to one another, movement of the gripping portion of the handles toward one another results in movement of the operational elements away from one another, that is, the stabilizing member is caused to move away from the spring adjustment member.

In order to access the spring for adjusting the spring in a manner to drive the spring away from the support panel, another preferred embodiment of the present invention is provided and may be described in the following manner.

According to another preferred embodiment of the present invention, a device for adjusting a quarter turn fastener is provided, with the quarter turn fastener being of the type having a spring extending between at least two spring fastening elements fixed to a support panel, the support panel defining a spring side wherein the spring projects therefrom and an outer side wherein the spring does not project therefrom, the support panel being formed with an access opening adjacent the spring for access to the spring from the outer side by a removable stud configured for spring engagement. The present device includes a generally elongate body including a generally elongate first arm having a chamber formed therein and being open at one end thereof and defining a gripping portion and a mating portion; a first adjustment head portion operatively associated with the first arm for operative engagement with the at least two spring fastening elements from the spring side of the panel; a second arm including a second gripping portion, the second arm being pivotably mounted to the first arm at the mating portion, thereby defining a pivot axis along the body, with the pivot axis being intermediate the gripping portions and the first adjustment head portion; and a second adjustment head portion for spring engagement and spring adjustment movement, the second adjustment head portion being formed as a slider disposed within the cavity formed in the first arm for reciprocal movement therein and projecting outwardly therefrom, the slider being operatively engaged with the second arm.

Therefore, movement of the second arm causes generally linear movement of the slider within the cavity and movement of the second adjustment head portion toward the spring while urging the first adjustment head portion toward the spring fastening elements.

Preferably, the slider includes a first gear rack formed on a surface thereof and the second arm includes a complimentary second gear rack formed on a surface thereof for operative mating engagement with the first gear rack whereby movement of the second arm causes the second gear rack to advance the first gear rack linearly within the cavity to drive the second adjustment head portion outwardly against the spring for adjustment thereof.

It is further preferred that the second adjustment head portion is configured for insertion through the access opening from the outer side of the support panel for engagement of the spring fastening elements on the spring side of the support panel.

Preferably, the second adjustment head portion includes a spring contact member formed on an end of the slider for generally linear movement therewith.

It is also preferred that the second adjustment head portion includes at least two rails selectively mounted to the first arm within the cavity and projecting outwardly therefrom, the rails defining a gap therebetween, wherein each rail is formed with a flange projecting laterally away therefrom and directed away from the first arm for engagement of each flange with at least one of the spring fastening elements on the spring side of the support panel.

It is preferred that the second adjustment head portion includes a spring contact member formed on an end of the slider for generally linear movement therewith and wherein the spring contact member moves generally linearly within the gap between the rails. The present device may further include a rod mounted to the slider and extending away therefrom in a direction away from the spring contact member for adjusting an operational travel distance of the slider. The rod may extend outwardly from the first arm and is configured to position the first gear rack relative to the second gear rack to define an operational slider travel distance.

Preferably, the rails are selectively positionable within the first arm to define a selected projection distance of the flange beyond the first arm for engagement with the spring fastening elements.

The second preferred embodiment of the present invention is configured for the head of the unit to be inserted through the stud access opening and each of the rivet engagement members is placed against a rivet. Once the handles are squeezed together, the spring adjustment member is advanced against the spring thereby driving the spring away from the support surface.

By the foregoing, the present invention provides a simple, rapid solution to adjusting quarter-turn fasteners which may be effectively performed under automotive competition conditions.

### BRIEF DESCRIPTION OF THE DRAWINGS

FIG. 1 is a cutaway view of a prior art quarter-turn fastener of the type adjusted by the present invention;

FIG. 2 is a perspective view of the components of a prior art quarter-turn fastener as illustrated in FIG. 1;

FIG. 3 is a side view of a device for adjusting a quarter turn fastener according to a first preferred embodiment of the present invention;

FIG. 4 is a perspective view of the spring adjustment head components of the device illustrated in FIG. 3;

FIG. 5 is an operational view of the device illustrated in FIG. 3;

FIG. 6 is a side view of a device for adjusting a quarter turn fastener according to a second preferred embodiment of the present invention;

FIG. 7 is a top perspective view of the device illustrated in FIG. 6;

FIG. 8 is a second top perspective view of the device illustrated in FIG. 6 illustrating the advance of the spring adjustment member;

FIG. 9 is a third top perspective view of the device illustrated in FIG. 6 illustrating the full advance of the spring adjustment member; and

FIG. 10 is an operational view of the device illustrated in FIG. 6.

### DESCRIPTION OF THE PREFERRED EMBODIMENTS

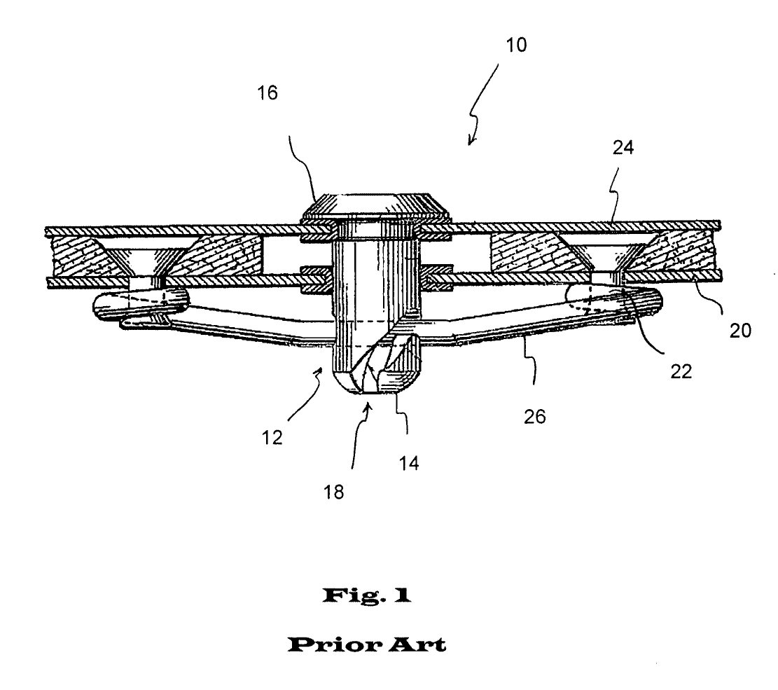

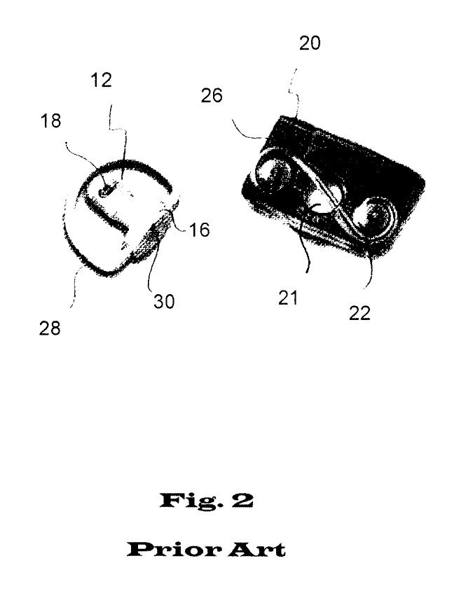

Turning now to the drawings and, more particularly to FIG. 1, a prior art fastener known as a DZUS® fastener is illustrated generally at 10 and is shown in a partial cross-sectional environmental view. There, two surfaces 20, 24 are joined together, including an outer mounted panel 24 and a support surface or panel 20. A stud access opening 21 is provided intermediate the rivets 22. A spring formed from wire is illustrated generally at 26 and extends between the rivets 22. A pair of rivets 22 used to mount the spring are embedded in the surfaces 20, 24 a predetermined distance apart. The spring 26 its coiled around each rivet 22 and, with reference to FIG. 2, comes away from each rivet 22 at approximately a 30 degree angle to extend laterally across the stud access opening 21.

With reference to FIG. 1, a stud 12 includes a shank 14 and a head 16. A curved slot forming a camming surface is illustrated at 18 and is formed in the shank 14 with an opening directed downwardly for spring engagement. A screwdriver access slot 30, as seen in FIG. 2, is included for providing the quarter turn movement required to fasten and unfasten the quarter turn fastener using a conventional screwdriver. In addition to the slot 30, a D-ring 28 may be applied for manual use without a screwdriver in attaining the necessary quarter turn.

In operation, the stud 12 is inserted in the access opening 21 and the spring 26 is engaged with the slot 18 such that the spring surface tracks the camming surface through the slot. When the stud is turned ¼ turn, either via the D-ring 28 or the screwdriver slot 30, the spring 26 tracks the camming surface and at the end of the travel path, the spring is allowed to flex outwardly, away from the support surface and fits snuggly against the surface of the slot 18 such that the spring is prevented from returning to its stable state and therefore maintains downward pressure on the slot surface of the shank 14 of the stud 12 to maintain the mounted panel 24 in place due to its contact with the head 16.

Since such fasteners are typically used in environments that are less than ideal that include heat, vibration, sudden jolts and other mechanical events, the spring may become maladjusted in that it extends too closely to the support surface 20 or too far away from the support surface 20 for proper engagement with the stud 12. If the spring surface 26 is too far away from the stud 12 when it is inserted in the opening, no engagement may be made and therefore, the fastener will fail to function as a fastener. If the spring is too close to the support surface 20 the slot engagement may occur, but insufficiently for spring tension to hold the stud 12 and therefore the mounted panel 24 securely in place. The mounted panel 24 may vibrate causing further damage to the surface, the fastener or both.

It should be noted that typically such surfaces that are mounted using quarter turn fasteners are lightweight surfaces that do not tax the ability of the quarter turn fastener to maintain an effective mount. Therefore, such surfaces are typically a lightweight, thin material that may be damaged if hand tools are used to pry against the surface.

When the spring becomes maladjusted, access can be difficult and slow or prevent proper readjustment of the spring. Due to the internal body structure of the support vehicle to which the panel is mounted using the presently discussed fasteners, conventional tools such as screwdrivers or pliers may not provide sufficient pressure on the spring due to the inability to effectively access the spring and the inability to provide a support surface to push against to form a fulcrum for lever action to bend the spring back into proper alignment. It should be noted that those with ordinary skill in the art know when the spring is properly aligned and, in a straightforward manner, can manipulate the spring between a misaligned or maladjusted position and a fully adjusted, fully usable position, given the right tools.

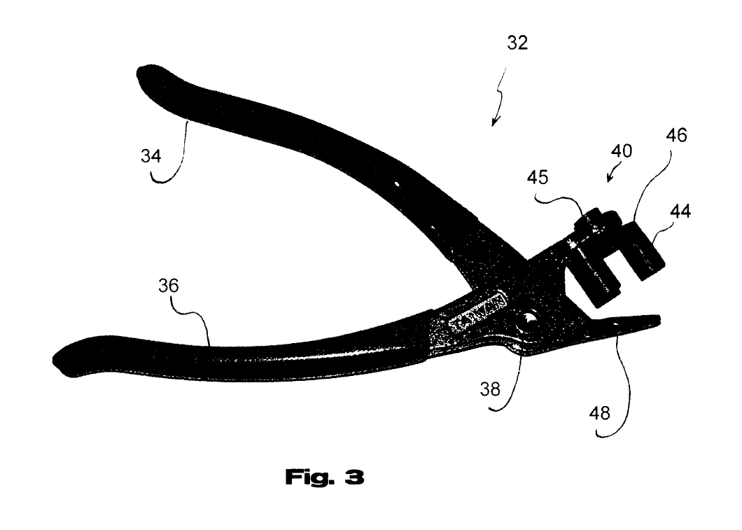

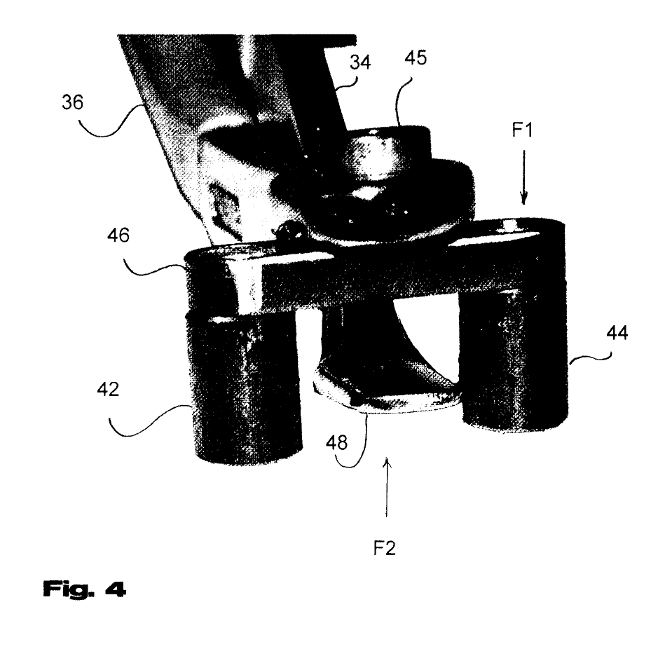

Turning now to FIG. 3, a first preferred embodiment of the present invention is illustrated generally at 32 and includes opposing handles 34, 36 that are joined at a pivot point 38 to define an axis therethrough in the manner of a pair of pliers. A first portion of an adjustment head assembly 40, also illustrated in FIG. 4, is mounted the first handle 36 and includes a laterally extended cross-member 46 and two generally perpendicularly oriented rivet engagement members 42, 44 that are spaced a predetermined distance apart by the cross-member 46 with the predetermined spacing distance being the same as the distance between the rivets in the aforesaid fastener structure. The cross-member 46 is rotatably mounted to the first arm 36 for rotation about a pivot 45. Such ability of the cross-member to rotate enhances the ease with which the rivets 22 are engaged by the rivet engagement members 42, 44 when positioning the present device for use.

The second handle 34 includes a second portion of the adjustment head assembly in the form of an outwardly projecting spring adjustment member 46 that moves in opposition to the first portion of the adjustment head 40 when the device is in use.

With reference to FIG. 4, The downward force illustrated at F₁ is counteracted by the upwardly directed force F₂. The downwardly directed force F₁ is pressed against the rivets through the rivet engagement members 42, 44 while the upwardly directed force F₂ is applied to the spring 26 through the spring adjustment member 48.

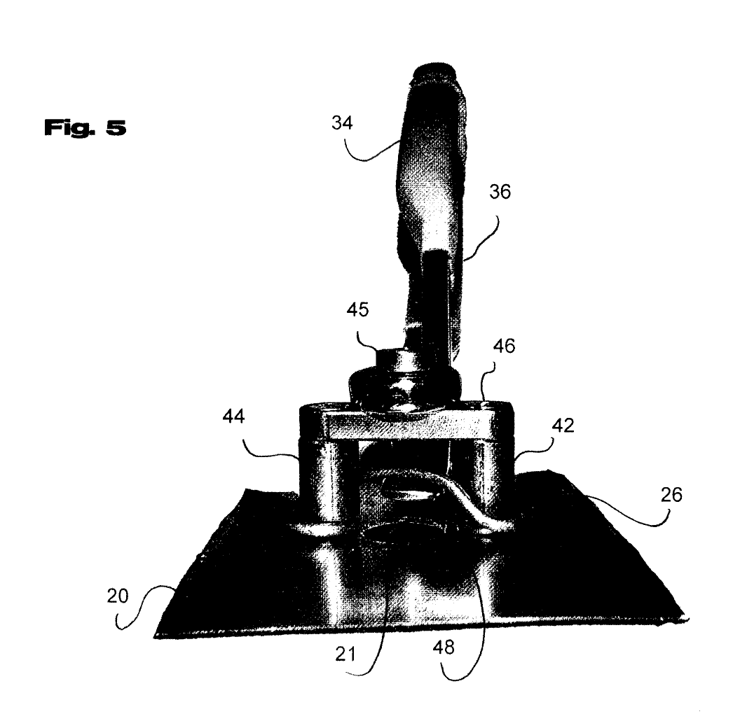

As seen in FIG. 5, the rivet engagement members 42, 44 are fitted on top of the rivets with the spring adjustment member 48 fitted underneath the spring 26 such that when the handles 34, 36 are squeezed together in the manner of a pair of pliers, the aforesaid downwardly directed force F₁ presses on the rivets 22 while the upwardly directed force F₂ is used to adjust the spring 26 with the spring adjustment member 48.

Accordingly, by use of the first embodiment of the present invention, the spring 26 may accessed by the present device from the spring side of the support panel and the spring may then be adjusted in a manner to move it farther away from the support surface 20 and then to proper alignment for use.

Under certain conditions, the first embodiment of the present invention may be used to move the spring toward the support surface 20. In that regard, the spring adjustment member 48 must be placed on the upper surface of the spring 26 such that downward movement of the spring adjustment member 48 will press downwardly on the spring. The conditions must be sufficient that the handles may be moved away from one another in an effective manner to provide sufficient downward pressure on the rivets using the rivet engagement members 42, 44 while also providing sufficient downward force on the spring engagement member 48. While it is not impossible to deflect a spring toward the support surface 20 using the first embodiment of the present invention, it is not as straightforward as applying the first embodiment of the present invention in a manner to move the spring closer to the support surface 26.

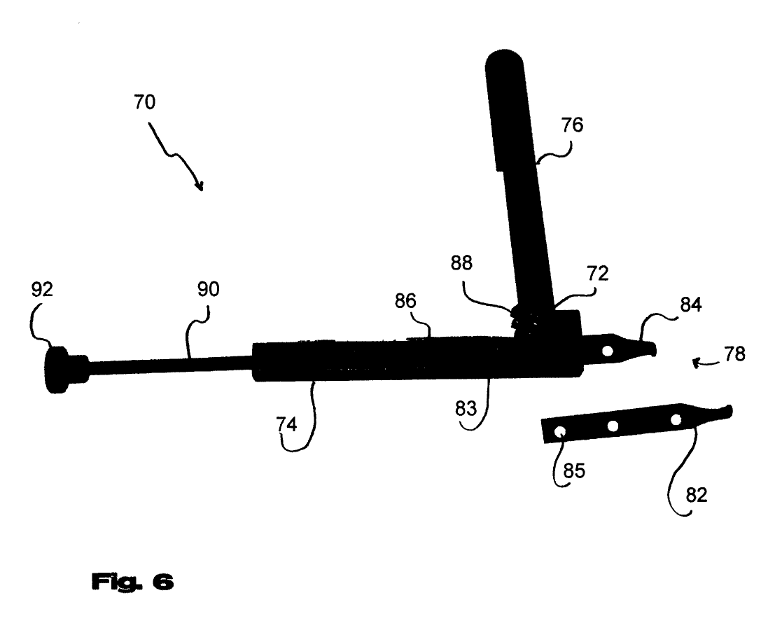

With reference to FIG. 6, the second preferred embodiment of the present invention is illustrated at 70 and includes a primary handle 74 pivotally mounted to an operational handle 76 at a pivot point 72, thereby defining a pivot axis thereat. A spring adjustment head assembly 78 projects outwardly from the primary handle 74 beyond the pivot point 72. The spring adjustment head assembly 78 includes a slider that is slidably mounted within the primary handle 74, and includes a spring engagement element 80 on one end thereof.

A rack-based gear set 86, 88 includes dual, interactive rack components mounted to the handles 74, 76 such that when the operational handle 76 is drawn to the primary handle 74, the head 78 is driven outwardly. The slider is attached to a shaft 90 having an adjustment hub 92 attached to a distal end thereof. Selective Linear movement of the shaft 90 moves the slider and therefore the spring engagement member 80 either toward or away from spring engagement and positions the first gear rack 86 with respect to the second, driving gear rack 88 to define a length of travel for the spring engagement member 80 during use.

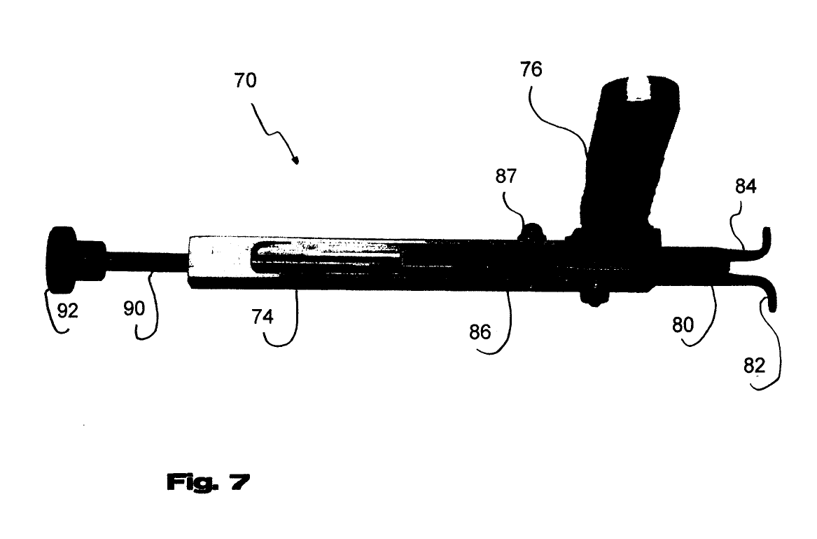

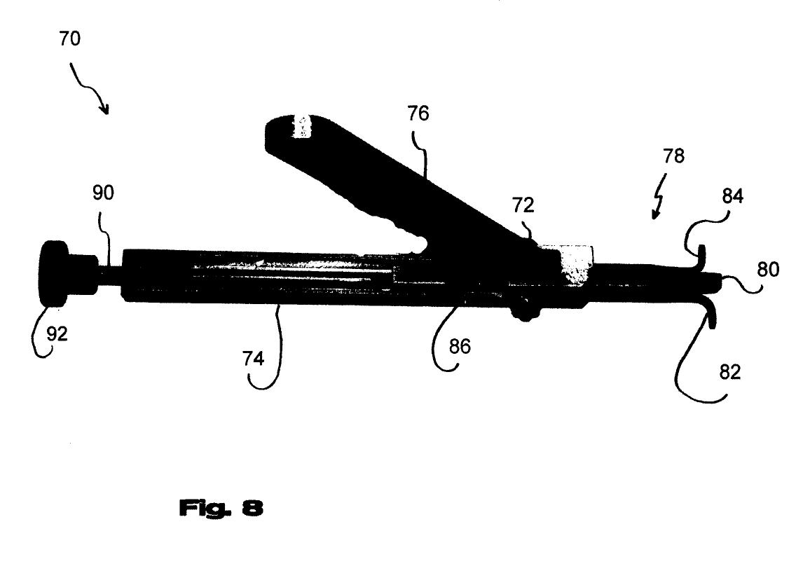

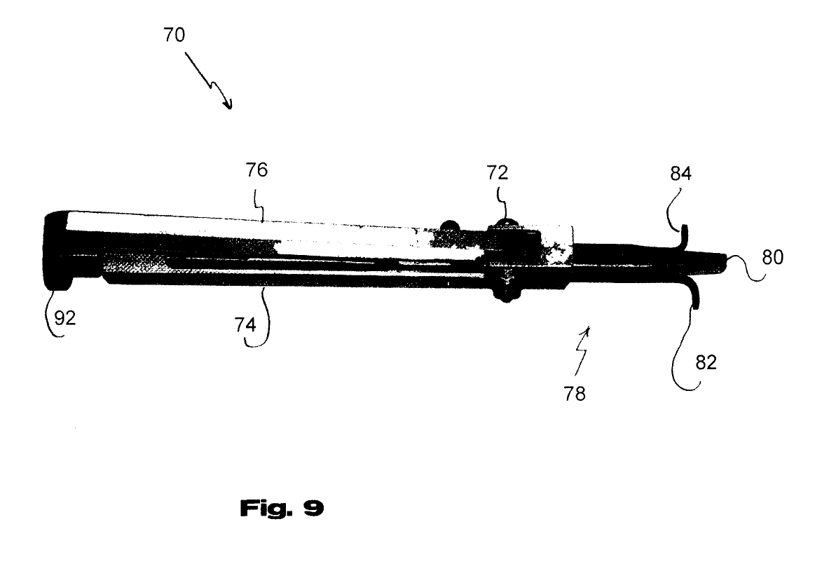

A pair of rivet engagement elements 82, 84 are adjustably mounted to the forst handle 74 by screws on each rail attached to the first handle 74 at screw mounts 83, 87 to project outwardly form the first handle 74. The rivet engagement elements 82, 84 are each formed with rivet engaging flanges configured to project laterally way from one another and laterally away from the spring engagement element 80. This relationship is best seen in FIGS. 7-10.

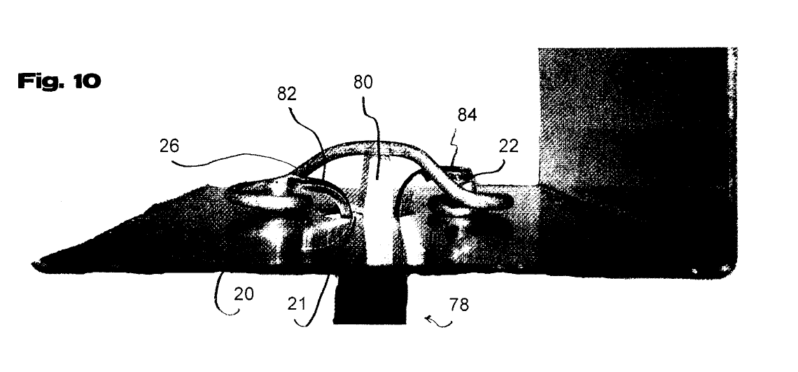

As seen in FIGS. 7-10, in operation, the head assembly 78 is extended through the stud access opening 21 and positioned with the rivet engagement elements 82, 84 in engagement with the rivets 22, as seen in FIG. 10. With the spring engagement member 80 withdrawn into the first arm 74 using the rod 90, the rivet engagement elements can move toward one another sufficiently to be directed through the access opening 21. Then the rod 90 is used to position the spring engagement member 80 for spring adjustment by positioning the gear racks 86, 88 with respect to one another for operation by movement of the second handle 76. Then, the second handle 76 is drawn toward the first handle 74, thereby causing the rack gears 86, 88 to drive the spring adjustment member 80 outwardly away from the support surface 20 and thereby driving the spring 26 downwardly, away from the support surface 20, a predetermined distance for adjustment.

The second preferred embodiment of the present invention provides a device that will move the spring away from the support surface while accessing the spring from above the support surface.

The present invention provides a device for engaging the rivets associated with a quarter turn fastener and an apparatus for using leverage thereby gained to engage and bend the spring, all contact being from the spring side of the support panel.

It will therefore be readily understood by those persons skilled in the art that the present invention is susceptible of a broad utility and application. While the present invention is described in all currently foreseeable embodiments, there may be other, unforeseeable embodiments and adaptations of the present invention, as well as variations, modifications and equivalent arrangements, that do not depart from the substance or scope of the present invention. The foregoing disclosure is not intended or to be construed to limit the present invention or otherwise to exclude such other embodiments, adaptations, variations, modifications and equivalent arrangements, the present invention being limited only by the claims appended hereto and the equivalents thereof.

I claim:

1. A device for adjusting a quarter turn fastener, the quarter turn fastener being of the type having a spring extending between at least two spring fastening elements fixed to a support panel, the support panel being formed with an access opening adjacent the spring for access to the spring by a removable stud configured for spring engagement, the device comprising:
a generally elongate body including:
a first arm including a first gripping portion and a mating portion;
a first adjustment head portion operatively associated with the first arm for operative engagement with the at least two spring fastening elements;
a second arm including a second gripping portion, the second arm being pivotably mounted to the first arm at the mating portion, thereby defining a pivot axis along the body, with the pivot axis being intermediate the gripping portions and the first adjustment head portion; and
a second adjustment head portion for spring engagement and spring movement, the second adjustment head portion being operatively associated with the second arm, wherein movement of the second arm causes movement of the second adjustment head portion;
whereby relative movement of at least one of the first arm and the second arm toward the other causes the first adjustment head portion and the second adjustment head portion to be urged toward one another thereby directing pressure on the spring fastener elements by the first adjustment head portion while simultaneously directing pressure against the spring by the second adjustment head portion for selective spring adjustment.

2. A device for adjusting a quarter turn fastener according to claim 1 wherein the first adjustment head portion includes a traversely extending support member attached to an end portion of the first arm, and a pair of spring fastener engagement elements projecting laterally away from the traversely extending support member in a manner substantially perpendicular to the support member for placing substantially equal pressure on each spring fastening element using the first arm.

3. A device for adjusting a quarter turn fastener according to claim 2 wherein the traversely extending support member is rotatably mounted to the first arm.

4. A device for adjusting a quarter turn fastener according to claim 1 wherein the second adjustment head portion includes a spring engagement member attached to an end portion of the second arm.

5. A device for adjusting a quarter turn fastener according to claim 1 wherein the first arm is formed with a cavity for carrying the first adjustment head portion and the second adjustment head portion at least partially therein.

6. A device for adjusting a quarter turn fastener according to claim 5 wherein the second adjustment head portion is formed on a slider disposed within the cavity for reciprocal motion therein, the slider being formed with a first gear rack thereon, the second arm being formed with a second gear rack for operative engagement with the first gear rack for causing linear motion of the slider when the second arm is urged toward the first arm.

7. A device for adjusting a quarter turn fastener, the quarter turn fastener being of the type having a spring extending between at least two spring fastening elements fixed to a support panel, the support panel defining a spring side wherein the spring projects therefrom and an outer side wherein the spring does not project therefrom, the support panel being formed with an access opening adjacent the spring for access to the spring from the outer side by a removable stud configured for spring engagement, the device comprising:
a generally elongate body including:
a first arm including a first gripping portion and a mating portion;
a first adjustment head portion operatively associated with the first arm for operative engagement with the at least two spring fastening elements from the spring side of the panel;
a second arm including a second gripping portion, the second arm being pivotably mounted to the first arm at the mating portion, thereby defining a pivot axis along the body, with the pivot axis being intermediate the gripping portions and the first adjustment head portion; and
a second adjustment head portion for spring engagement and spring adjustment movement, the second adjustment head portion being mounted to one end of the second arm, wherein movement of the second arm causes movement of the second adjustment head portion;
whereby urging the first arm and the second arm toward one another causes the first adjustment head portion and the second adjustment head portion to be urged toward one another thereby directing pressure on the spring fastener elements by the first adjustment head portion while simultaneously directing pressure against the spring by the second adjustment head portion for spring adjustment.

8. A device for adjusting a quarter turn fastener according to claim 7 wherein the first adjustment head portion includes a traversely extending support member attached to an end portion of the first arm, and a pair of spring fastener engagement elements projecting laterally away from the traversely extending support member in a manner substantially perpendicular to the support member for placing substantially equal pressure on each spring fastening element using the first arm.

9. A device for adjusting a quarter turn fastener according to claim 8 wherein the traversely extending support member is rotatably mounted to the first arm.

10. A device for adjusting a quarter turn fastener according to claim 8 wherein the second adjustment head portion includes a spring engagement member attached to an end portion of the second arm.

11. A device for adjusting a quarter turn fastener according to claim 9 wherein the spring engagement member is formed as a generally planar member projecting outwardly from the second arm configured for rotational movement about the pivot axis in a direction opposite that of the arm rotation about the pivot axis.

12. A device for adjusting a quarter turn fastener, the quarter turn fastener being of the type having a spring extending between at least two spring fastening elements fixed to a support panel, the support panel defining a spring side wherein the spring projects therefrom and an outer side wherein the spring does not project therefrom, the support panel being formed with an access opening adjacent the spring for access to the spring from the outer side by a removable stud configured for spring engagement, the device comprising:
a generally elongate body including:
a generally elongate first arm having a chamber formed therein and being open at one end thereof and defining a gripping portion and a mating portion;
a first adjustment head portion operatively associated with the first arm for operative engagement with the at least two spring fastening elements from the spring side of the panel;
a second arm including a second gripping portion, the second arm being pivotably mounted to the first arm at the mating portion, thereby defining a pivot axis along the body, with the pivot axis being intermediate the gripping portions and the first adjustment head portion; and
a second adjustment head portion for spring engagement and spring adjustment movement, the second adjustment head portion being formed as a slider disposed within the cavity formed in the first arm for reciprocal movement therein and projecting outwardly therefrom, the slider being operatively engaged with the second arm;
whereby movement of the second arm causes generally linear movement of the slider within the cavity and movement of the second adjustment head portion toward the spring while urging the first adjustment head portion toward the spring fastening elements.

13. A device for adjusting a quarter turn fastener according to claim 12 wherein the slider includes a first gear rack formed on a surface thereof and the second arm includes a complimentary second gear rack formed on a surface thereof for operative mating engagement with the first gear rack whereby movement of the second arm causes the second gear rack to advance the first gear rack linearly within the cavity to drive the second adjustment head portion outwardly against the spring for adjustment thereof.

14. A device for adjusting a quarter turn fastener according to claim 12 wherein the second adjustment head portion is configured for insertion through the access opening from the outer side of the support panel for engagement of the spring fastening elements on the spring side of the support panel.

15. A device for adjusting a quarter turn fastener according to claim 14 wherein the second adjustment head portion includes a spring contact member formed on an end of the slider for generally linear movement therewith.

16. A device for adjusting a quarter turn fastener according to claim 12 wherein the second adjustment head portion includes at least two rails selectively mounted to the first arm within the cavity and projecting outwardly therefrom, the rails defining a gap therebetween, wherein each rail is formed with a flange projecting laterally away therefrom and directed away from the first arm for engagement of each flange with at least one of the spring fastening elements on the spring side of the support panel.

17. A device for adjusting a quarter turn fastener according to claim 16 wherein the second adjustment head portion includes a spring contact member formed on an end of the slider for generally linear movement therewith and wherein the spring contact member moves generally linearly within the gap between the rails.

18. A device for adjusting a quarter turn fastener according to claim 16 and further comprising a rod mounted to the slider and extending away therefrom in a direction away from the spring contact member for adjusting an operational travel distance of the slider.

19. A device for adjusting a quarter turn fastener according to claim 18 wherein the rod extends outwardly from the first arm and is configured to position the first gear rack relative to the second gear rack to define an operational slider travel distance.

20. A device for adjusting a quarter turn fastener according to claim 16 wherein the rails are selectively positionable within the first arm to define a selected projection distance of the flange beyond the first arm for engagement with the spring fastening elements.
